(19) United States
(12) Patent Application Publication
(10) Pub. No.: US 2006/0047070 A1
(43) Pub. Date: Mar. 2, 2006

(54) Thermoplastic elastomer compositions and molded products thereof

(75) Inventor: Yasushi Hirota, Nagoya-shi (JP)

Correspondence Address: NIXON & VANDERHYE, PC, 901 NORTH GLEBE ROAD, 11TH FLOOR, ARLINGTON, VA, 22203, US

(73) Assignee: Advanced Plastics Compounds Company, Tokyo (JP)

(21) Appl. No.: 11/192,407

(22) Filed: Jul. 29, 2005

(30) Foreign Application Priority Data
Sep. 1, 2004 (JP) 2004-254189

(51) Int. Cl. C08L 53/00

(52) U.S. Cl. 525/88

(57) ABSTRACT

The thermoplastic elastomer composition comprises the following components (A) and (B) at a specific blending ratio, wherein the component (A) is a propylene-based copolymer satisfying the following conditions (a1) to (a3): (a1) the propylene-based copolymer being composed of a copolymer of propylene with the other α-olefin having 2 to 8 carbon atoms, (a2) in the copolymer, a content of components soluble in xylene at room temperature being 10 to 60% by weight, and
(a3) in the components soluble in xylene at room temperature, a content of α-olefin other than propylene being 5 to 30% by weight; and the component (B) is a block copolymer represented by the general formula: A(B-A)ₙ and/or (A-B)ₙ (wherein A is a monovinyl-substituted aromatic hydrocarbon polymer block, B is a conjugated diene polymer block, and n is an integer of 1 to 5), or a hydrogenated product thereof. The thermoplastic elastomer composition of the present invention exhibits excellent gloss and scratch resistance.

### BACKGROUND OF THE INVENTION

The present invention relates to thermoplastic elastomer compositions and molded products thereof, and more particularly, to thermoplastic elastomer compositions exhibiting not only a good appearance, in particular, a good gloss, but also an excellent scratch resistance, and molded products thereof.

For example, automobile exterior moldings such as automobile window frames, have been required to have not only excellent scratch resistance, weather resistance and heat resistance, but also an excellent appearance, in particular, a high metallic luster or gloss.

Conventionally, soft vinyl chloride resins have been mainly used as materials for the above moldings. In recent years, there has been an increased demand for replacing the vinyl chloride resins with olefin-based resin materials in view of problems such as weight reduction, etc.

However, the olefin-based resin materials, in particular, soft materials such as olefin-based elastomers and styrene-based elastomers, tend to readily suffer from scratches or scuffs as compared to the soft vinyl chloride resins, and further have such a problem that scratches or scuffs formed on these materials become more remarkable as a surface gloss thereof is increased.

For this reason, there have been proposed extrusion-molded products in which high-hardness resin compositions containing ethylene-(meth)acrylic acid copolymers, ionomer resins or high-crystallinity polypropylene resins are used for a design surface thereof (for example, Japanese Utility Model Registration No. 2597587 and Japanese Patent Application Laid-Open (KOKAI) No. 11-208273(1999)).

However, in the case of injection-molded members, it may be difficult to cover a whole design surface thereof with these materials, so that a base material of the members is required to have a good gloss. Further, since the base material is also required to exhibit a flexibility to some extent, it may be extremely difficult to satisfy both of gloss and scratch resistance.

### SUMMARY OF THE INVENTION

The present invention has been conducted in view of the above problems. An object of the present invention is to provide a thermoplastic elastomer composition exhibiting a good gloss and an excellent scratch resistance.

As a result of the present inventors' earnest studies, it has been found that the above object can be readily accomplished by using a thermoplastic elastomer composed of a specific propylene-based copolymer and a specific block copolymer. The present invention has been attained on the basis of the above finding.

To accomplish the aim, in a first aspect of the present invention, there is provided a thermoplastic elastomer composition comprising 30 to 70% by weight of a component (A) and 30 to 70% by weight of a component (B), with the proviso that a total content of the components (A) and (B) is 100% by weight, wherein the component (A) is a propylene-based copolymer satisfying the following conditions (a1) to (a3):
(a1) the propylene-based copolymer being composed of a copolymer of propylene with the other α-olefin having 2 to 8 carbon atoms;
(a2) in the copolymer, a content of components soluble in xylene at room temperature being 10 to 60% by weight; and
(a3) in the components soluble in xylene at room temperature, a content of α-olefin other than propylene being 5 to 30% by weight; and
the component (B) is a block copolymer represented by the general formula: A(B-A)ₙ, (A-B)ₙ or combination of A(B-A)ₙ and (A-B)ₙ (wherein A is a monovinyl-substituted aromatic hydrocarbon polymer block, B is a conjugated diene polymer block, and n is an integer of 1 to 5), or a hydrogenated product thereof.

In a second aspect of the present invention, there is provided a molded product produced by injection-molding the above thermoplastic elastomer composition.

### DETAILED DESCRIPTION OF THE INVENTION

The present invention is described in detail below. The thermoplastic elastomer composition of the present invention contains the specific components (A) and (B) as essential components.

The component (A) used in the present invention is a propylene-based copolymer satisfying the following conditions (a1) to (a3):
(a1) the propylene-based copolymer being composed of a copolymer of propylene with the other α-olefin having 2 to 8 carbon atoms;
(a2) in the copolymer, a content of components soluble in xylene at room temperature being 10 to 60% by weight; and
(a3) in the components soluble in xylene at room temperature, a content of α-olefin other than propylene being 5 to 30% by weight.

Examples of the other α-olefin used in the copolymer (a1) may include ethylene, 1-butene, 3-methyl-1-butene, 1-pentene, 4-methyl-1-pentene, 1-hexene and 1-octene. Among these α-olefins, especially preferred is ethylene.

The content of the components soluble in xylene at room temperature (hereinafter referred to merely as “CXS”) in the above condition (a2) is preferably 20 to 50% by weight, and the content of the α-olefin other than propylene (hereinafter referred to merely as “αT”) in the above condition (a3) is preferably 10 to 20% by weight.

When the content of CXS is less than 10% by weight, the resultant composition tends to be deteriorated in flexibility. On the other hand, when the content of the CXS is more than 60% by weight, the resultant composition tends to be deteriorated in scratch resistance. When the content of the αT is less than 5% by weight, the resultant composition tends to be deteriorated in flexibility. On the other hand, when the content of the αT is more than 30% by weight, the resultant composition tends to be deteriorated in scratch resistance.

Also, the melting point peak temperature of the propylene-based copolymer is preferably not less than 155° C., more preferably not less than 160° C. When the melting point peak temperature of the propylene-based copolymer is less than 155° C., bleed-out of low-molecular weight components from the resin base material tends to be caused.

The process for producing the propylene-based copolymer is not particularly limited. For example, there may be used production processes described in Japanese Patent Application Laid-Open (KOKAI) Nos. 2001-226435 and 2001-172454, etc. In the preferred embodiment of the present invention, the production process comprises at least two stages including a first stage in which a propylene homopolymer is produced, and a second or subsequent stage in which a copolymer of propylene and the other α-olefin having 2 to 8 carbon atoms is produced. The preferred production process is described in more detail below.

The catalyst used in the above successive polymerization process is not particularly limited, and is preferably composed of a solid component containing an organoaluminum compound, a titanium atom, a magnesium atom, a halogen atom and an electron-donating compound as essential components. Such catalysts are already known in the art.

The organoaluminum compound include those compounds represented by the general formula:
R¹ₘAlX₍₃₋ₘ₎
(wherein R¹ is a hydrocarbon residue having 1 to 12 carbon atoms; X is a halogen atom; and m is a number of 1 to 3). Examples of the organoaluminum compound may include trialkyl aluminums such as trimethyl aluminum and triethyl aluminum, dialkyl aluminum halides such as dimethyl aluminum chloride and diethyl aluminum chloride, alkyl aluminum sesquihalides such as methyl aluminum sesquichloride and ethyl aluminum sesquichloride, alkyl aluminum dihalides such as methyl aluminum dichloride and ethyl aluminum dichloride, and alkyl aluminum hydrides such as diethyl aluminum hydride.

In the above solid component of the catalyst, the titanium compound as a source of the titanium atom include those compounds represented by the general formula:
Ti(OR²)₍₄₋ₙ₎Xₙ
(wherein R² is a hydrocarbon residue having 1 to 10 carbon atoms; X is a halogen atom; and n is a number of 0 to 4). Among these titanium compounds, especially preferred are titanium tetrachloride, tetraethoxytitanium and tetrabutoxytitanium.

Examples of the magnesium compound as a source of the magnesium atom used in the solid component of the catalyst may include dialkyl magnesiums, magnesium dihalides, dialkoxymagnesiums and alkoxymagnesium halides. Among these magnesium compounds, especially preferred are magnesium dihalides.

Examples of the halogen atom used in the solid component of the catalyst may include fluorine, chlorine, bromine and iodine. Among these halogen atoms, especially preferred is chlorine. These halogen atoms may be usually supplied from the above titanium compounds or the above magnesium compounds. Alternatively, the halogen atoms may also be supplied from the other halogen sources such as aluminum halides, silicon halides and tungsten halides.

Typical examples of the electron-donating compound used in the solid component of the catalyst may include oxygen-containing compounds and nitrogen-containing compounds. Specific examples of the oxygen-containing compounds may include alcohols, phenols, ketones, aldehydes, carboxylic acids, organic acids, inorganic acids and derivatives thereof. Specific examples of the nitrogen-containing compounds may include ammonia, amines, nitrites and isocyanates. Among these electron-donating compounds, preferred are inorganic acid esters, organic acid esters and organic acid halides; more preferred are silicic esters, phthalic esters, cellosolve acetate ester and phthalic halides; and still more preferred are organosilicon compounds represented by the general formula:
R³.R⁴₍₃₋ₚ₎Si(OR⁵)ₚ
wherein R³ is a branched aliphatic hydrocarbon residue having 3 to 20 carbon atoms, preferably 4 to 10 carbon atoms, or a cyclic aliphatic hydrocarbon residue having 5 to 20 carbon atoms, preferably 6 to 10 carbon atoms; R⁴ is a branched or linear aliphatic hydrocarbon residue having 1 to 20 carbon atoms, preferably 1 to 10 carbon atoms; R⁵ is an aliphatic hydrocarbon residue having 1 to 10 carbon atoms, preferably 1 to 4 carbon atoms; and p is a number of 1 to 3.

Specific examples of the preferred organosilicon compounds represented by the above general formula may include t-butyl-methyl-dimethoxysilane, t-butyl-methyl-diethoxysilane, cyclohexyl-methyl-dimethoxysilane and cyclohexyl-methyl-diethoxysilane.

In the above successive polymerization process, at the first stage thereof, propylene solely or propylene and the other α-olefin having 2 to 8 carbon atoms are supplied to the reaction system and polymerized in the presence of the above catalyst at a temperature of 50 to 150° C., preferably 50 to 100° C. under a propylene partial pressure of 0.5 to 4.5 MPa, preferably 1.0 to 3.5 MPa to produce a propylene homopolymer. Successively, at the second stage, propylene and ethylene, or propylene, ethylene and α-olefin having 4 to 8 carbon atoms are supplied to the reaction system and polymerized in the presence of the above catalyst at a temperature of 50 to 150° C., preferably 50 to 100° C. while keeping each of propylene and ethylene partial pressures at 0.3 to 4.5 MPa, preferably 0.5 to 3.5 MPa, thereby producing a propylene-ethylene copolymer or a propylene-ethylene-α-olefin copolymer.

Meanwhile, the above polymerization may be conducted by any of a batch method, a continuous method and a semi-batch method. The first stage polymerization may be performed in either a gas phase or a liquid phase. Further, the second stage polymerization may also be performed in either a gas phase or a liquid phase, preferably in a gas phase. The residence time in the respective stages is 0.5 to 10 hours, preferably 1 to 5 hours for each stage.

In addition, when particles of the resultant propylene-based copolymer suffer from problems such as stickiness, in order to impart a good fluidity to the particles, an active hydrogen-containing compound is preferably added thereto either after completion of the first stage polymerization, before initiation of the second stage polymerization, or during the second stage polymerization. Examples of the active hydrogen-containing compound may include water, alcohols, phenols, aldehydes, carboxylic acids, acid amides, ammonia and amines. The amount of the active hydrogen-containing compound used is usually 100 to 1000 moles per mole of titanium atom contained in the solid component of the catalyst, and 2 to 5 moles per mole of the organoaluminum compound contained in the catalyst.

The component (B) used in the present invention is a block copolymer (vinyl-substituted aromatic hydrocarbon/conjugated diene copolymer) represented by the general formula: A(B-A)ₙ and/or (A-B)ₙ (wherein A is a monovinyl-substituted aromatic hydrocarbon polymer block; B is a conjugated diene polymer block; and n is an integer of 1 to 5), or a hydrogenated product thereof.

The vinyl-substituted aromatic hydrocarbon as a monomer constituting the polymer block (A) is styrene or a derivative thereof. Specific examples of the styrene derivative may include α-methyl styrene, 1-vinyl naphthalene, 2-vinyl naphthalene, 3-methyl styrene, 4-propyl styrene, 4-cyclohexyl styrene, 4-dodecyl styrene, 2-ethyl-4-benzyl styrene and 4-(phenylbutyl)styrene. In particular, the polymer component constituting the polymer black (A) is preferably a styrene polymer, an α-methyl styrene polymer or a copolymer of styrene and α-methyl styrene. Also, examples of the preferred conjugated diene monomer constituting the polymer block (B) may include butadiene, isoprene and a mixture thereof.

The method for producing the above block copolymer is not particularly limited. For example, the block polymerization may be conducted in an inert solvent in the presence of a lithium catalyst by the method described in Japanese Patent Publication (KOKOKU) No. 40-23798(1965).

Further, the hydrogenation treatment of the block copolymer may be conducted in an inert solvent in the presence of a hydrogenation catalyst, for example, by the methods described in Japanese Patent Publication (KOKOKU) Nos. 42-8704(1967) and 43-6636(1968), Japanese Patent Application Laid-Open (KOKAI) Nos. 59-133203(1984) and 60-79005(1985), etc. In the hydrogenation treatment, at least 50% by weight, preferably not less than 80% by weight of olefinically double bonds contained in the polymer block (B) are hydrogenated, whereas not more than 25% by weight of aromatically unsaturated bonds contained in the polymer block (A) are hydrogenated. Such hydrogenated block copolymers are commercially available, for example, as “KRATON-G” (tradename) from Kraton Polymers Corp., “SEPTON” (tradename) from Kuraray Co., Ltd., and “TOFTEC” (tradename) and “SOE-SS” (tradename) both from Asahi Kasei Co., Ltd.

Further, the thermoplastic elastomer composition of the present invention may be blended with a lubricant for the purpose of enhancing a scratch resistance thereof. Examples of the lubricant may include organosiloxanes such as dimethyl polysiloxane, methylphenyl polysiloxane and methylhydrogen polysiloxane; aliphatic acid amides, e.g., monoamides of higher fatty acids such as stearylamide, oxystearylamide, oleylamide, erucylamide, laurylamide, palmitylamide and behenylamide, modified monoamides such as methylolamide and ethylolamide, composite amides such as stearyloleylamide and N-stearylerucamide, and bisamide-type higher fatty acid amides such as methylenebisstearylamide and ethylenebisstearylamide; and polyethylene waxes ordinarily used as the lubricant for olefin-based resins. These lubricants may be used in combination of any tow or more thereof. The amount of the lubricant blended is usually not more than 20% by weight, preferably not more than 10% by weight based on the weight of the resin used.

Further, the thermoplastic elastomer composition of the present invention may contain, in addition to the above-mentioned components, other optional components for various purposes unless the addition thereof adversely affects the effects of the present invention. Examples of the optional components blended may include various additives such as antioxidants, heat stabilizers, light stabilizers, ultraviolet absorbers, neutralizing agents, anti-fogging agents, anti-blocking agents, slip agents, dispersants, colorants, flame retardants, antistatic agents, conductivity-imparting agents, metal deactivators, molecular weight modifiers, germicides, mildew-proof agents and fluorescent brighteners; inorganic fillers, or the like. In the consideration of exterior use of the resultant composition, among these optional components, antioxidants, light stabilizers, ultraviolet absorbers and colorants are preferably added thereto. The amount of the optional components blended is usually not more than 10% by weight, preferably not more than 5% by weight based on the weight of the resin used.

The thermoplastic elastomer composition of the present invention may be prepared, for example, using an ordinary kneader such as a single-screw extruder, a twin-screw extruder, a Banbury mixer, rolls, a brabender, a plastograph and a kneader.

The thermoplastic elastomer composition of the present invention can be suitably applied to resin molded products for exterior use, in particular, automobile exterior parts such as window moldings, roof moldings and glass channels because of excellent surface appearance, flexibility, weather resistance, heat resistance, hot water resistance and scratch resistance thereof. From the practical viewpoints, the thermoplastic elastomer composition of the present invention is required to exhibit a hardness of usually 55 to 90, preferably 60 to 80, a surface gloss of usually not less than 5%, preferably 10 to 30%, a scratch resistance (surface roughness Ra) of usually not more than 1.0 μm, preferably not more than 0.6 μm. Meanwhile, these properties may be measured by the methods described below in Examples.

In accordance with the present invention, there are provided thermoplastic elastomer compositions having not only a high gloss but also excellent flexibility and scratch resistance, in particular, thermoplastic elastomer compositions which can be suitably used in applications such as injection-molded automobile moldings.

### EXAMPLES

The present invention is described in more detail by the following Examples, but these Examples are only illustrative and not intended to limit the scope of the present invention. In the following examples and comparative examples, the materials used therein are as follows.

### (1) Propylene-Based Copolymer

Propylene-ethylene copolymer produced according to the method described in Example 2 of Japanese Patent Application Laid-Open (KOKAI) No. 2001-226435 (ethylene content in the copolymer: 11% by weight; content of components soluble in xylene at room temperature: 35% by weight; ethylene content in the components soluble in xylene at room temperature: 18% by weight; melting point peak temperature of the copolymer: 164° C.)

### (2) Polypropylene Resin

“NOVATEC PP BC1” produced by Nippon Polypropylene Corporation (block PP; flexural modulus: 1350 MPa; MFR (as measured at 230° C. under 21.18 N): 15)

### (3) Block Copolymer (1)

“SEPTON 4055” produced by Kuraray Co., Ltd. (hydrogenated styrene-based rubber)

### (4) Block Copolymer (2)

“SOE-SS L605” produced by Asahi Kasei Corporation (hydrogenated styrene-based rubber)

### (5) EPDM

“EP504EC” produced by JSR Co., Ltd. (ethylene content: 70% by weight; ethylidene norbornene content: 5.5% by weight; oil extended amount: 100% by weight; Mooney viscosity as measured according to ASTM D-927-57T (ML 1+4; 100° C.): 400)

### (6) Mineral Oil-Based Softening Agent

Paraffin oil “PW-90” produced by Idemitsu Kosan Co., Ltd.

### (7) 2,5-dimethyl-2,5-di(t-butylperoxy)hexane (Crosslinking Agent)

“KAYAHEXANE AD” produced by Kayaku Akzo Corporation

### (8) Triallyl isocyanate (Crosslinking Assistant)

“TAIC” produced by Nippon Kayaku Chemical Co., Ltd.

### (9) Oleylamide

“ARMO-CP” produced by Lion Akzo Corporation

### (10) Carbon Black (CB) Master Batch

“F30940MM” (polyethylene:carbon black=60:40 (weight ratio)) produced by Dai-Nippon Ink and Chemicals, Incorporated

### (11) Olefin-Based Elastomer (1)

“THERMORUN 3755B” produced by Mitsubishi Chemical Corporation

### (12) Olefin-Based Elastomer (2)

“MIRASTOMER 7030B” produced by Mitsui Chemicals Co., Ltd.

### (13) Olefin-Based Elastomer (3)

“SANTOPRENE 121-55W241” produced by AES Japan Co., Ltd.

### Examples 1 to 5 and Comparative Examples 1 to 6

The respective components were blended with each other at a mixing ratio shown in Table 1. The obtained mixture was melted and kneaded at a resin temperature of 220° C. using a 30 mmφ unidirectional-rotation twin-screw extruder, and then pelletized. Further, the obtained pellets were injection-molded using a 75-t injection molding machine whose cylinder was separated into four zones which were respectively set to a temperature of 180° C., 210° C., 220° C. and 210° C., thereby forming a test specimen of 80 mm in length, 120 mm in width and 2 mm in thickness.

Then, the thus obtained test specimen was subjected to measurements of a hardness (according to JIS K6253) and a surface gloss (according to JIS Z8741) thereof. Further, in order to evaluate a scratch resistance of the test specimen, the surface of the test specimen was linearly scratched 100 times with a commercially available nylon brush under a vertical load of 200 g using a HEIDON Scratch Tester, and a center-line average roughness Ra of the thus scratched test specimen was measured according to JIS B0701 using a surface roughness tester manufactured by Tokyo Seimitsu Co., Ltd. The results are shown together in Table 1.

As is apparent from Table 1, it was confirmed that when the specific two components, i.e., the specific propylene-based copolymer and block copolymer as resin components, were blended with each other according to the present invention, the obtained thermoplastic elastomer composition exhibited a good balance between gloss, flexibility and scratch resistance, which has never been attained conventionally. On the other hand, as shown in Comparative Example 1, when the propylene-based copolymer solely was used, the resultant material was deteriorated in flexibility. Further, as shown in Comparative Examples 2 to 4, when the olefin-based elastomer solely was used, the obtained materials were deteriorated in surface gloss and scratch resistance. In addition, as shown in Comparative Example 5, even though the propylene-based copolymer was used together with the other components, in the case where EPDM was used as the other component, the resultant composition was deteriorated in surface gloss and scratch resistance. Also, as shown in Comparative Example 6, even though the block copolymer was used together with the other components, in the case where the polypropylene resin is used as the other component, the resultant composition was deteriorated in surface gloss.

TABLE 1

| | Examples | | | | |
|---|---|---|---|---|---|
| Components | 1 | 2 | 3 | 4 | 5 |
| Composition | | | | | |
| Propylene-based copolymer | 40 | 40 | 40 | 40 | 20 |
| Polypropylene resin | — | — | — | — | — |
| Block copolymer (1) | 24 | 24 | 18 | 28 | 32 |
| Block copolymer (2) | — | — | 15 | — | — |
| EPDM | — | — | — | — | — |
| Mineral oil-based softening | 36 | 36 | 27 | 42 | 48 |
| agent | | | | | |
| 2,5-dimethyl-2,5-di(t- | — | — | — | — | — |
| butylperoxy)hexane | | | | | |
| Triallyl isocyanate | — | — | — | — | — |
| Olefin-based elastomer (1) | — | — | — | — | — |
| Olefin-based elastomer (2) | — | — | — | — | — |
| Olefin-based elastomer (3) | — | — | — | — | — |
| CB master batch | 2 | 2 | 2 | 2 | — |
| Oleylamide | — | 0.2 | — | — | — |
| Evaluation items | | | | | |
| Hardness | 75 | 75 | 75 | 68 | 63 |
| Surface gloss (%) | 27 | 27 | 29 | 20 | 17 |
| Scratch resistance (surface | 0.5 | 0.4 | 0.3 | 0.4 | 0.5 |
| roughness Ra) (%) | | | | | |

| | Comparative Examples | | | | | |
|---|---|---|---|---|---|---|
| Components | 1 | 2 | 3 | 4 | 5 | 6 |
| Composition | | | | | | |
| Propylene-based copolymer | 100 | — | — | — | 30 | — |
| Polypropylene resin | — | — | — | — | — | 23 |
| Block copolymer (1) | — | — | — | — | — | 28 |
| Block copolymer (2) | — | — | — | — | — | — |
| EPDM | — | — | — | — | 70 | — |
| Mineral oil-based softening | — | — | — | — | — | 42 |
| agent | | | | | | |
| 2,5-dimethyl-2,5-di(t- | — | — | — | — | 0.3 | — |
| butylperoxy)hexane | | | | | | |
| Triallyl isocyanate | — | — | — | — | 0.4 | — |
| Olefin-based elastomer (1) | — | 100 | — | — | — | — |
| Olefin-based elastomer (2) | — | — | 100 | — | — | — |
| Olefin-based elastomer (3) | — | — | — | 100 | — | — |
| CB master batch | — | — | — | — | 2 | 2 |
| Oleylamide | — | — | — | — | 0.2 | 0.2 |
| Evaluation items | | | | | | |
| Hardness | 98 | 75 | 70 | 58 | 75 | 72 |
| Surface gloss (%) | 57 | 3.7 | 3.5 | 3.4 | 4.1 | 4.3 |
| Scratch resistance (surface | 0.1 | 1.5 | 2.1 | 2.8 | 1.2 | 0.8 |
| roughness Ra) (%) | | | | | | |

What is claimed is:

1. A thermoplastic elastomer composition comprising:
(A) 30 to 70% by weight of a propylene-based copolymer satisfying the following conditions (a1) to (a3):
(a1) the propylene-based copolymer being composed of a copolymer of propylene with the other α-olefin having 2 to 8 carbon atoms,
(a2) in the copolymer, a content of components soluble in xylene at room temperature being 10 to 60% by weight, and
(a3) in the components soluble in xylene at room temperature, a content of α-olefin other than propylene being 5 to 30% by weight; and
(B) 70 to 30% by weight of a block copolymer represented by the general formula: A(B-A)ₙ, (A-B)ₙ or combination of A(B-A)ₙ and (A-B)ₙ, wherein A is a monovinyl-substituted aromatic hydrocarbon polymer block, B is a conjugated diene polymer block, and n is an integer of 1 to 5, or a hydrogenated product thereof, with the proviso that a total content of the components (A) and (B) is 100% by weight.

2. A thermoplastic elastomer composition according to claim 1, wherein the propylene-based copolymer has a melting point peak temperature of not lower than 155° C.

3. A thermoplastic elastomer composition according to claim 1, wherein the propylene-based copolymer is produced by a polymerization process having at least two stages comprising a first stage in which a propylene homopolymer is produced, and a second or subsequent stage in which propylene and ethylene are used as essential components to produce the copolymer of propylene with the other α-olefin having 2 to 8 carbon atoms.

4. A thermoplastic elastomer composition according to claim 1, further comprising (C) a mineral oil-based softening agent in an amount of 5 to 150% by weight based on 100% by weight of a total weight of the components (A) and (B).

5. A molded product produced by injection-molding the thermoplastic elastomer composition as defined in claim 1.
